(19) United States
(12) Patent Application Publication
(10) Pub. No.: US 2009/0162513 A1
(43) Pub. Date: Jun. 25, 2009

(54) Rice hull composition

(76) Inventors: Leo Gingras, Scottsdale, AZ (US); Paul Mathewson, Scottsdale, AZ (US); Rani Madhavapeddi Patel, Phoenix, AZ (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/317,085

(22) Filed: Dec. 19, 2008

Related U.S. Application Data
(60) Provisional application No. 61/015,577, filed on Dec. 20, 2007.

(51) Int. Cl. A23L 1/308; A21D 13/00

(52) U.S. Cl. 426/551; 426/618

(57) ABSTRACT

A consumable food composition is provided containing rice hull particles or blends of rice hull particles and bran. The food compositions have excellent fiber content and are advantageously nutritious.

### CROSS-REFERENCE TO RELATED APPLICATIONS

This application claims priority to U.S. Provisional Application No. 61/015,577, filed Dec. 20, 2007, which is hereby incorporated by reference.

### FEDERALLY SPONSORED RESEARCH OR DEVELOPMENT

Not Applicable.

### TECHNICAL FIELD

This invention relates to dietary food compositions, and more particularly, to high fiber food compositions using rice hulls or a blend of rice hulls and rice bran as the source of fiber.

### BACKGROUND OF THE INVENTION

It is well recognized today that dietary fiber in the human diet has significant positive long-term health effects among which are improved Taxation, lowering of serum cholesterol levels, aiding in weight loss, possibly reducing the incidence of some types of cancer and controlling serum glucose levels. The currently recommended level of dietary fiber for adult humans is 25-28 grams per day for a 2000 kcal diet. The recommended level of dietary fiber for an adult female is 25 grams per day and the recommended level for an adult male is 28 grams per day. Because current human diets tend to be high in refined foods, the level of fiber consumption is, to a large extent, inadequate for achieving the health benefits associated with fiber consumption.

Dietary fiber is a heterogeneous group of substances having only one common characteristic: the non-digestibility in the small bowel. By and large, all fibers are non-caloric carbohydrate polymers(poly- or disaccharides). Some fibers are water-soluble, others are insoluble, a property associated with physiological effects. Soluble (viscous) fibers can bind water and thus form hydrocolloids or gels, whereas insoluble fibers cannot form gels.

There are many potential sources of fiber for the human diet. Among the most commonly used fiber sources in foods today are corn, wheat and oats. However, despite the wide variety of fiber sources, there remains a lack of fiber in the typical human diet.

About 600 million metric tons of rice are annually produced throughout the world. Rice is composed of three basic components namely the hull, the bran and the kernel. The kernel, the hull, and the bran layer represent approximately 70%, 20%, and 10%, respectively, of the rough rice. Currently, 60 million metric tons of rice bran are generated from rice milling operations worldwide. Rice hulls, a by-product of the milling industry, have received little attention as a food source and indeed, have limited nutritive value except as a source of indigestible fiber. At present, a small portion of the rice hull and rice bran by-products resulting from rice milling operation is used in the preparation of animal feed, and the remainder is typically discarded. The current focus on dietary fiber as an essential part of an overall human diet has generated increased interest in rice hull as a fiber source, which is known to contain approximately 70% dietary fiber. When ground to an appropriate particle size, rice hulls can be easily incorporated into many food product formulations, significantly raising the level of dietary fiber in the finished product. Advantageously, the high fiber content of rice hulls makes it one of the best sources of food-grade fiber available to the food industry. Although high in fiber, rice hulls provide little in the way of additional energy-producing nutrients.

Rice hull has received less attention as a source of fiber suitable for food products, but its availability and low cost offers significant advantages over standard fiber sources. The present invention satisfies the need for more fiber in human diets by providing an inexpensive alternative for use of the underutilized rice hull and rice bran fractions in the preparation of food compositions with higher fiber content.

### SUMMARY OF THE INVENTION

The present invention provides dietary fiber food compositions having a practical shelf-life, and containing an amount of fiber to provide at least a portion of the recommended daily allowance of fiber in the typical diet.

In one embodiment, the present invention provides a consumable food composition, comprising a plurality of rice hull particles and a dough. Depending on the application, the rice hull particle size is in the range of about 20 to about 1000 microns, and the particles are admixed with a dough, such as a bread dough.

In another embodiment, the present invention provides a consumable food composition, comprising ground rice hull particles, wherein the rice hull particles are blended with a cereal bran, such as rice bran. The bran material derived from other cereals such as wheat and corn is also suitable for blending with ground rice hull. The use of blends of rice hulls and rice bran accomplishes the goal of providing both an effective source of dietary fiber as well as a source of high quality protein, minerals and other micronutrients. In yet another embodiment, the present invention provides a food composition comprising a blend of rice hull and rice bran and a dough.

Bran materials derived from cereal grains such as wheat, oats, corn, and barley can be used in place of rice bran. The bran materials derived from oil seed milling are also suitable for the purpose of preparing high fiber food composition of the present invention.

The bran material used in the present invention is subjected to certain post-milling processes to make the bran stable during storage. The stabilized bran material may further be subjected to extraction with organic solvent to produce fully or partially defatted bran material to increase the relative proportion of fiber content in the bran material.

These and other aspects of the invention will become more apparent when read with the detailed description which follows.

### DETAILED DESCRIPTION

The present invention provides consumable food compositions having a high fiber content with a practical shelf-life, and which maximizes the benefits of fiber to consumers. In certain embodiments, the present invention provides a food composition, comprising appropriate amount of rice hull or a blend of rice hull and rice bran to achieve dietary fiber content which could be considered either as a good source of fiber or an excellent source of fiber. Reference Daily Intake (RDI) and the Daily Reference Value (DRV) are the basis for declaring nutrient content of a particular food composition. Thus the recommended daily allowance for fiber or RDI for fiber based on a 2000 kcal diet for an adult female is 25 grams. A food that has 5 grams of fiber per serving would state on the label that the percent daily value for fiber is 20 percent. For a food composition to be considered as a good source of fiber, it must contain 10 to 19% DRV. In other words, the food composition should have a fiber content at least between 2.5 grams and 4.75 grams of fiber per serving in order to be considered as a good source of fiber. For a food composition to be considered as an excellent source of fiber, it must contain 20% or more of the DRV. The nutritional requirement in human food consumption is also determined by the recommended dietary allowance, which is defined as the average daily dietary intake level that is sufficient to meet the nutrient requirement of nearly all healthy individuals.

The amount of either the rice hull material or rice hull and rice bran blend may be adjusted to achieve the rating of either a good source of fiber or an excellent source of fiber. The addition of rice hull or rice hull and rice bran blend as a fiber supplement to a food composition is dependent on the original level of fiber in the starting food composition, as well as the target fiber level to be achieved in the food composition. In addition, the amount of fiber supplement is a function of the serving size of the food composition. A person with ordinary knowledge in the preparation of food compositions having defined nutritional values will be able to determine the appropriate amount of rice hull or blend of rice hull and rice bran necessary to prepare a food composition that is either a good or excellent source of fiber.

When rice is harvested in the form of paddy or rough rice, the kernel is enveloped by a rice hull. After being dried, rice is milled to remove the hull, yielding brown rice. In a second stage of milling, the outer brown layer is removed from the rice kernel to yield polished or white rice. While the rice hull fraction resulting from the first stage of rice milling is highly stable, the rice bran fraction produced in the second stage of rice milling operation is problematic in terms of functional and organoleptice stability because of its high lipid content. The composition of rice bran (in percent by weight) is generally 7-10% water, 18-21% oil, 12-16% crude protein, 6-8% crude fiber, 9-12% ash and 45-55% carbohydrate. Besides having high percentage of oil, the rice bran contains significant lipolytic and oxidative enzyme activities. The milling process releases these enzymes, which can hydrolyze/oxidize the lipids associated with bran and germ fractions, leading to generation of compounds that contribute to the undesirable taste and odors characteristic of rancidity. Formation of these compounds can be quite rapid and their presence in food products represents a significant barrier to widespread inclusion of bran/germ fraction in food formulation. Several methods have been developed to stabilize the germ and bran fraction resulting from the cereal milling including application of direct heat and/or steam treatments, extrusion methods, pan roasting and microwave roasting techniques. These various stabilization techniques inactivate the lipolytic and oxidative enzymes present in the bran materials and produce a stabilized bran fraction with a longer shelf-life.

In certain aspects, it is further desirable to reduce the oil content of rice bran by utilizing a defatting process. Defatting is accomplished by extracting the oils using for example, an organic solvent. The oil/solvent solution is then separated from the bran portion resulting in a bran fraction with greatly reduced oil content. The oil fraction recovered from this organic extraction procedure is good for human consumption. The resulting bran fraction resulting from this extraction procedure using organic solvent is either fully defatted or partially defatted. This fully defatted or partially defatted bran fraction is stable and, on a percentage basis, has an increased level of dietary fiber relative to stabilized rice bran. The level of dietary fiber in stabilized rice bran (“SRB”) is approximately 30% while the level of dietary fiber in defatted rice bran increases to approximately 40%.

The present invention also involves the use of blends of rice hulls and rice bran resulting in a product providing both an effective source of dietary fiber, as well as, a source of high quality protein, minerals and other micronutrients.

Certain stabilized rice bran derivatives are disclosed in the following commonly owned U.S. Patents including: U.S. Pat. No. 5,985,344, issued Nov. 16, 1999, entitled, “Process for Obtaining Micronutrient Enriched Rice Bran Oil:” U.S. Pat. No. 6,126,943, issued Oct. 3, 2000, and entitled, Method for Treating Hypercholesterolemia, Hyperlipidemia, and Atherosclerosis;” U.S. Pat. No. 6,303,586 issued Oct. 16, 2001, and entitled “Supportive Therapy for Diabetes, Hyperglycemia and Hypoglycemia;” U.S. Pat. No. 6,350,473, issued Feb. 26, 2002 and entitled “Method for Treating Hypercholesterolemia, Hyperlipidemia, and Atherosclerosis;” U.S. Pat. No. 6,558,714, issued May 6, 2003, and entitled “Method for Treating Hypercholesterolemia, Hyperlipidemia, and Atherosclerosis;” U.S. Pat. No. 6,733,799 issued May 11, 2004, and entitled “Method for Treating Hypercholesterolemia, Hyperlipidemia, and Atherosclerosis;” and U.S. Pat. No. 6,902,739, issued Jun. 7, 2005, and entitled “Method for Treating Joint Inflammation, Pain, and Loss of Mobility.” Each of the foregoing patents are hereby incorporated by reference.

In certain aspects, the rice hull particles are admixed with a “dough” to form the food formulation. Dough is a paste made out of any cereal or leguminous crop flour by mixing the flour with an appropriate amount of water. In another embodiment of the invention, rice hulls may be blended with the bran portion of the rice. The rice hull is combined either with the stabilized bran or with a stabilized and defatted rice bran.

To be used effectively as a food ingredient such blends of rice bran and rice hull should be ground to an appropriate particle size. The particle size distribution is important for functional and sensory reasons. For example, the particle size will determine how fast the particle absorbs water. If the process is relatively fast, a large rice hull particle may not have time to fully hydrate. That may reduce its functionality in cases where water binding or retention is an important attribute. If the particle is not hydrated sufficiently, it may have a coarser, gritty texture that will not contribute positively to the desired product sensory characteristics. The rice hulls are usually ground in ball mills or pulverized and may be sieved. Any suitable means and devices known in the art for grinding the rice hulls can be used to produce rice hull particles of appropriate dimension. Finely ground rice hulls are also commercially available. The commercially available ground rice hull materials have a fiber content of 39.0 to 43.0%. Depending on the application, the particle size of the ground rice hull material may be in the range of 20 to about 1000 microns but more preferably in the range from about 40 to 300 microns. The specific particle size will be a function of the desired characteristics and the mechanical requirements of the means of producing the finished product.

The relative proportions of a rice bran and rice hull blend used in a food composition will depend on the desired level of nutrient content versus fiber content in the finished product. The ratio of rice hull to rice bran in the inventive blend may vary from 5% rice hull and 95% rice bran to 95% rice hull and 5% rice bran but will more preferably be within the range of 25% rice hull and 75% rice bran to 75% rice hull and 25% rice bran.

In making a consumable food product, such as cakes, cookies, ready-to-eat cereals, by any known method in the art, appropriate amount of either the ground rice hull or a blend of ground rice hull and bran material may be mixed with the cereal ingredient. For example, in preparing a ready-to-eat cereal snack with enhanced fiber content, 2% (w/w) ground rice hull can be added to the flour and other ingredients and blended. The resulting dough is cut to size, baked and packaged using known methods. Alternatively, 2% (w/w) of a blend comprising 25% ground rice hull and 75% rice bran can be added to the flour and other ingredients and blended. The resulting dough is cut to size, baked and packaged, again using known methods.

It may further be desirable to use rice hulls as the primary source of the fiber component in blends with other bran materials from other cereals such as wheat, oat, corn and barley. The bran materials derived form oil seeds may also be combined with rice hull preparation to produce food composition with appropriate amount of fiber.

The disclosed novel fiber sources may be incorporated into a variety of food formulations and oven-baked items, such as in crackers, cookies, breads and other such food comestibles. Bread products according to the invention include, but are not limited to, white bread, wheat bread, tortillas, rolls and buns, specialty/artisan breads, rye bread, whole grain varietals, bagels, pasta, grain-based snack foods, cereals, crackers, cookies, cakes, muffins, pastries, pancakes, pizza crusts, doughnuts, grain-based nutritional supplements, and salty snacks such as pretzels, tortilla chips, and corn chips. The food compositions containing rice hull or a blend of rice hull and rice bran may also be further machined by extrusion to produce ready-to-eat (RTE) cereals, snack products and other such configurations for human consumption. The amount of rice hulls or rice hull and rice bran blends added to these food products is based on the knowledge of one skilled in the art in food compositions, as well as the desired level of dietary fiber in the end product.

### EXAMPLE 1

### Ready-to-Eat Cereal Snacks Formulated With Rice Hull

A ready-to-eat (RTE) cereal or snack is provided and may be made by any suitable method for making RTE cereals such as methods involving flaking, rolling or extruding. More particularly, the RTE cereal or snack is a cooked flour or grain-based food into which milled rice hulls may be added as an additional source of functional fiber. The particle size of the rice hull material should be such that it blends uniformly and is approximately the same particle size distribution of the other major formula components. The rice hulls may constitute from 2 to 60% of the formulation, more preferably from 5-50%, and most preferably from 10 to 40% of the formulation.

During production of the RTE cereal or snack, the milled rice hulls are dispersed throughout the dough, such as by adding to a flour or grain mixture and mixing thoroughly. The dough containing the milled rice hulls is cooked and/or extruded. The cooked and/or extruded material is formed into discrete pieces such as by cutting or slicing.

A ready-to-eat flour-based food product composed of ingredients in accordance with the invention may be made having the following ingredients and amounts in the base mix: 30-95% Flour, 1-60% milled rice hulls, 3-9% sugars of various sorts, 1-7% salt, and 0.01-1.5% minor ingredient/flavorings.

A preconditioned flour mixture of the foregoing composition is formed with the specified ingredients and water or steam is added resulting in a fixed moisture content of about 15-25%, or a range between about 10-35%. The preconditioned mixture is a free-flowing wet plastic solid and can be introduced into an extruder at, for example, a temperature of about 100-150° F. and processed through the extruder which is capable of operating at an internal temperature of up to approximately 350° F. Upon exiting the extruder, the cooked resulting product is cut into individual pieces to form a cooked ready-to-eat cereal having milled rice hull particles uniformly incorporated throughout the bulk of the cereal pieces. The formed cereal pieces may be dried and subsequently packaged.

While the invention has been described with respect to certain preferred embodiments, as will be appreciated by those skilled in the art, it is to be understood that the invention is capable of numerous changes, modifications and rearrangements and such chances, modifications and rearrangements are intended to be covered by the following claims.

All publications, patents and patent applications mentioned in this specification are herein incorporated by reference into the specification in their entirety for all purposes. As will be apparent to persons skilled in the art, modifications and adaptations to the above-described invention can be made without departing from the spirit and scope of the invention, which is defined and circumscribed by the appended claims.

What is claimed is:

1. A consumable food composition comprising at least one cereal ingredient and ground rice hull in an amount sufficient to provide at least a portion of the recommended daily allowance of fiber.

2. The consumable food composition of claim 1, wherein the ground rice hull has particle size in the range of from about 20 micron to 2000 microns.

3. The consumable food composition of claim 1, wherein the particle size of the ground rice hull particles is in the range of from about 40 microns to 300 microns.

4. The consumable food composition of claim 1, the composition further comprising a bran

5. The consumable food composition of claim 4, wherein the bran is obtained from a cereal grain.

6. The consumable food composition of claim 4, wherein the bran is obtained from an oil seed.

7. The consumable food composition of claim 4, wherein the bran is rice bran.

8. The consumable food composition of claim 4, wherein the ground rice hull and rice bran are in the ratio of 5% to 95%, respectively.

9. The consumable food composition of claim 4, wherein the ground rice hull and bran are in the ration of 95% to 5%, respectively.

10. The consumable food composition of claim 4, wherein the ground rice hull and bran are in the ratio of 25% to 75%, respectively.

11. The consumable food composition of claim 4, wherein the ground rice hull and bran are in the ratio of 75% to 25%, respectively.

12. The consumable food composition of claim 4, wherein the bran is a stabilized bran.

13. The consumable food composition of claim 4, wherein the bran is a stabilized, defatted bran.

14. The consumable food composition of claim 1, wherein the food composition is selected from a group consisting of a ready-to-eat cereal, a brownie, a muffin, a crisped cereal, a tortilla, a cracker, a cookie, and a bread.

15. A consumable food composition, comprising:
at least one cereal ingredient;
ground rice hull particles in the size range of about 20 to 2000 microns;
and a rice bran wherein the ratio of rice bran to ground rice hull are in an amount sufficient to provide an increase in the fiber content of the food composition.
